(19) United States
(12) Patent Application Publication
(10) Pub. No.: US 2017/0062865 A1
(43) Pub. Date: Mar. 2, 2017

(54) DOUBLE-SIDED ALL-SOLID-STATE THIN-FILM LITHIUM BATTERY AND MANUFACTURING METHOD THEREOF

(71) Applicant: Institute of Nuclear Energy Research, Atomic Energy Council, Executive Yuan, R.O.C., Taoyuan (TW)

(72) Inventors: CHI-HUNG SU, Taoyuan (TW); YUAN-RUEI JHENG, Taoyuan (TW); DER-JUN JAN, Taoyuan County (TW); TIEN-HSIANG HSUEH, NEW TAIPEI (TW); YUH-JENQ YU, Taoyuan (TW)

(21) Appl. No.: 15/097,489

(22) Filed: Apr. 13, 2016

(30) Foreign Application Priority Data
Aug. 28, 2015 (TW) 104128420

(51) Int. Cl. H01M 10/04; H01M 4/485; H01M 4/04; H01M 4/38; H01M 4/583; H01M 10/0525; H01M 4/48

(52) U.S. Cl. CPC H01M 10/04; H01M 10/0525; H01M 4/485; H01M 4/483; H01M 4/48; H01M 4/386; H01M 4/382; H01M 4/583; H01M 4/0426; H01M 4/0428; H01M 4/0423; H01M 4/0419; H01M 4/0416

(57) ABSTRACT

A double-sided all-solid-state thin-film lithium battery is provided, which may include a conductive substrate, a first upper electrode layer, a second upper electrode, an upper electrolyte layer, an upper current collecting layer, a first lower electrode layer, a second lower electrode layer, a lower electrolyte layer and a lower current collecting layer. The first upper electrode layer may be disposed at one side of the conductive substrate. The upper electrolyte layer may be disposed between the first and the second upper electrode layer. The upper current collecting layer may be disposed at one side of the second upper electrode layer. The first lower electrode layer may be disposed at the other side of the conductive substrate. The lower electrolyte layer may be disposed between the first and the second lower electrode layer. The lower current collecting layer may be disposed at one side of the second lower electrode layer.

This application also claims priority to Taiwan Patent Application No. 104128420 filed in the Taiwan Patent Office on Aug. 28, 2015, the entire content of which is incorporated herein by reference.

### TECHNICAL FIELD

The present disclosure relates to a battery, in particular to a thin-film lithium battery. The present disclosure also relates to the manufacturing method of the battery.

### BACKGROUND

The major difference between all-solid-state thin-film battery and conventional lithium battery is that conventional lithium battery uses liquid electrolyte, but all-solid-state thin-film battery uses solid/colloid electrolyte; solid/colloid electrolyte can improve many shortcomings of liquid electrolyte. The major advantages of all-solid-state are light, thin, of high safety, of long service life, of high charge/discharge current tolerance, highly flexible, and being able to be charged or discharged under high temperature.

However, the current processing technology cannot effectively increase the volumetric energy density; therefore, how to improve the current processing technology has become an important issue.

Currently, many technologies relevant to all-solid-state thin-film lithium battery have been developed, such as U.S. Pat. No. 7,540,886, Taiwan Patent Publication No. 200909802, European Union Patent No. 1928051; however, these technologies still cannot solve the shortcomings of current processing technology to effectively increase the volumetric energy density of all-solid-state thin-film battery.

Therefore, it has become an important issue to provide an all-solid-state thin-film battery and the manufacturing method thereof capable of effectively solving the problem that the volumetric energy density of all-solid-state thin-film battery cannot be increased.

### SUMMARY

The present disclosure is related to a double-sided all-solid-state thin-film lithium battery. In one embodiment of the disclosure, the double-sided all-solid-state thin-film lithium battery may include a conductive substrate, a first upper electrode layer, a second upper electrode, an upper electrolyte layer, an upper current collecting layer, a first lower electrode layer, a second lower electrode layer, a lower electrolyte layer and a lower current collecting layer. The first upper electrode layer may be disposed at one side of the conductive substrate. The upper electrolyte layer may be disposed between the first upper electrode layer and the second upper electrode layer. The upper current collecting layer may be disposed at one side of the second upper electrode layer. The first lower electrode layer may be disposed at the other side of the conductive substrate. The lower electrolyte layer may be disposed between the first lower electrode layer and the second lower electrode layer. The lower current collecting layer may be disposed at one side of the second lower electrode layer.

In a preferred embodiment of the present invention, each of the first upper electrode layer, the second upper electrode layer, the first lower electrode layer, and the second lower electrode layer may include an active material.

In a preferred embodiment of the present invention, the active material may be LiMn₂O₄, LiCoO₂, LiFePO₄, LiNiO₂, C, Si, SnO₂, TiO₂, Li, or a derivative, an alloy, a composite thereof.

In a preferred embodiment of the present invention, the upper electrolyte layer may simultaneously contact the conductive substrate, the first upper electrode layer, and the second upper electrode layer.

In a preferred embodiment of the present invention, the lower electrolyte layer may simultaneously contact the conductive substrate, the first lower electrode layer, and the second lower electrode layer.

In a preferred embodiment of the present invention, the conductive substrate may be a metal substrate.

In a preferred embodiment of the present invention, the metal substrate may be a stainless steel substrate.

In a preferred embodiment of the present invention, the conductive substrate may include an isolation substrate, a first substrate current collecting layer, and a second substrate current collecting layer; the first substrate current collecting layer may be disposed at one side of the isolation substrate, and the second substrate current collecting layer may be disposed at the other side of the isolation substrate.

In a preferred embodiment of the present invention, the upper electrolyte layer and the lower electrolyte layer may be solid or colloidal.

The present disclosure is related to a method for manufacturing a double-sided all-solid-state thin-film lithium battery. In another embodiment of the disclosure, the method may include the following steps: providing a conductive substrate; depositing an active material film at both sides of the conductive substrate by a film coating method to form a first upper electrode layer and a first lower electrode layer respectively; and forming an upper electrolyte layer at one side of the first upper electrode layer, and forming a lower electrolyte layer at one side of the first lower electrode layer.

In a preferred embodiment of the present invention, the method may further include the following step: forming an upper current collecting layer at one side of the first upper electrolyte layer, and forming a lower current collecting layer at one side of the first lower electrolyte layer.

In a preferred embodiment of the present invention, the method may further include the following step: performing an annealing process to process the active material films at the both sides of the conductive substrate.

In a preferred embodiment of the present invention, the active material may be LiMn₂O₄, LiCoO₂, LiFePO₄, LiNiO₂, C, Si, SnO₂, TiO₂, Li, or a derivative, an alloy, a composite thereof.

In a preferred embodiment of the present invention, the upper electrolyte layer may simultaneously contact the conductive substrate, the first upper electrode layer, and the second upper electrode layer.

In a preferred embodiment of the present invention, the lower electrolyte layer may simultaneously contact the conductive substrate, the first lower electrode layer, and the second lower electrode layer.

In a preferred embodiment of the present invention, the conductive substrate may be a metal substrate.

In a preferred embodiment of the present invention, the metal substrate may be a stainless steel substrate.

In a preferred embodiment of the present invention, the conductive substrate may include an isolation substrate, a first substrate current collecting layer, and a second substrate current collecting layer; the first substrate current collecting layer may be disposed at one side of the isolation substrate, and the second substrate current collecting layer may be disposed at the other side of the isolation substrate.

In a preferred embodiment of the present invention, the upper electrolyte layer and the lower electrolyte layer may be solid or colloidal.

In a preferred embodiment of the present invention, the film coating method may be the vacuum thermal evaporation, the radio frequency sputtering, the radio frequency magnetron sputtering, the chemical vapor deposition, the electrospray deposition, the pulsed laser deposition, the slurry coating, and the sol-gel method.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is the first schematic view of the first embodiment of the double-sided all-solid-state thin-film battery in accordance with the present invention.

FIG. 2 is the second schematic view of the first embodiment of the double-sided all-solid-state thin-film battery in accordance with the present invention.

FIG. 3 is the third schematic view of the first embodiment of the double-sided all-solid-state thin-film battery in accordance with the present invention.

FIG. 4 is the flow chart of the first embodiment of the double-sided all-solid-state thin-film battery in accordance with the present invention.

FIG. 5 is the schematic view of the second embodiment of the double-sided all-solid-state thin-film battery in accordance with the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

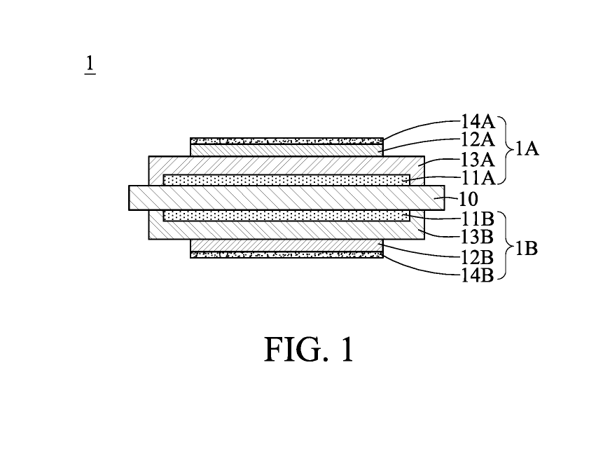

Please refer to FIG. 1, which is the first schematic view of the first embodiment of the double-sided all-solid-state thin-film battery in accordance with the present invention. As shown in FIG. 1, the double-sided all-solid-state thin-film lithium battery 1 may include a conductive substrate 10, an upper battery structure 1A, and a lower battery structure 1B. The upper battery structure 1A may include a first upper electrode layer 11A, a second upper electrode 12A, an upper electrolyte layer 13A, and an upper current collecting layer 14A. The lower battery structure 1B may include a first lower electrode layer 11B, a second lower electrode layer 12B, a lower electrolyte layer 13B and a lower current collecting layer 14B.

The first upper electrode layer 11A (the cathode or the anode) may be disposed at one side of the conductive substrate 10, where the conductive substrate 10 may be a metal substrate, such as stainless steel substrate, etc. The upper electrolyte layer 13A may be disposed between the first upper electrode layer 11A and the second upper electrode layer 12A (the cathode or the anode). In the embodiment, the upper electrolyte layer 13A may simultaneously contact the conductive substrate 10, the first upper electrode layer 11A, and the second upper electrode layer 12A; the upper electrolyte layer 13A may be solid or colloidal. The upper current collecting layer 14A may be disposed at one side of the second upper electrode layer 12A. The first lower electrode layer 11B (the cathode or the anode) may be disposed at the other side of the conductive substrate 10. The lower electrolyte layer 13B may be disposed between the first lower electrode layer 11B and the second lower electrode layer 12B (the cathode or the anode). In the embodiment, the lower electrolyte layer 13B may simultaneously contact the conductive substrate 10, the first lower electrode layer 11B, and the second lower electrode layer 12B; the lower electrolyte layer 13B may be solid or colloidal. The lower current collecting layer 14B may be disposed at one side of the second lower electrode layer 12B.

The first upper electrode layer 11A, the second upper electrode layer 12A, the first lower electrode layer 11B, and the second lower electrode layer 12B may include an active material, where the active material may be LiMn₂O₄, LiCoO₂, LiFePO₄, LiNiO₂, C, Si, SnO₂, TiO₂, Li, or a derivative, alloy, composite thereof.

As described above, in the embodiment, the both sides of the conductive substrate 10 of the double-sided all-solid-state thin-film lithium battery 1 may include the upper battery structure 1A and the lower battery structure 1B respectively; each of the upper battery structure 1A and the lower battery structure 1B has a complete battery structure, which can significantly increase the overall volumetric energy density of the double-sided all-solid-state thin-film lithium battery 1. In addition, the above special structure can take full advantage of the space of the both sides of the conductive substrate 10; therefore, the cost of the double-sided all-solid-state thin-film lithium battery 1 can be reduced. Further, the contact area between the current collecting layer and the active material can be significantly increased; thus, the electron conduction paths of the current collecting layer and the active material can be increased, which can obviously better the electrochemical performance of the double-sided all-solid-state thin-film lithium battery 1.

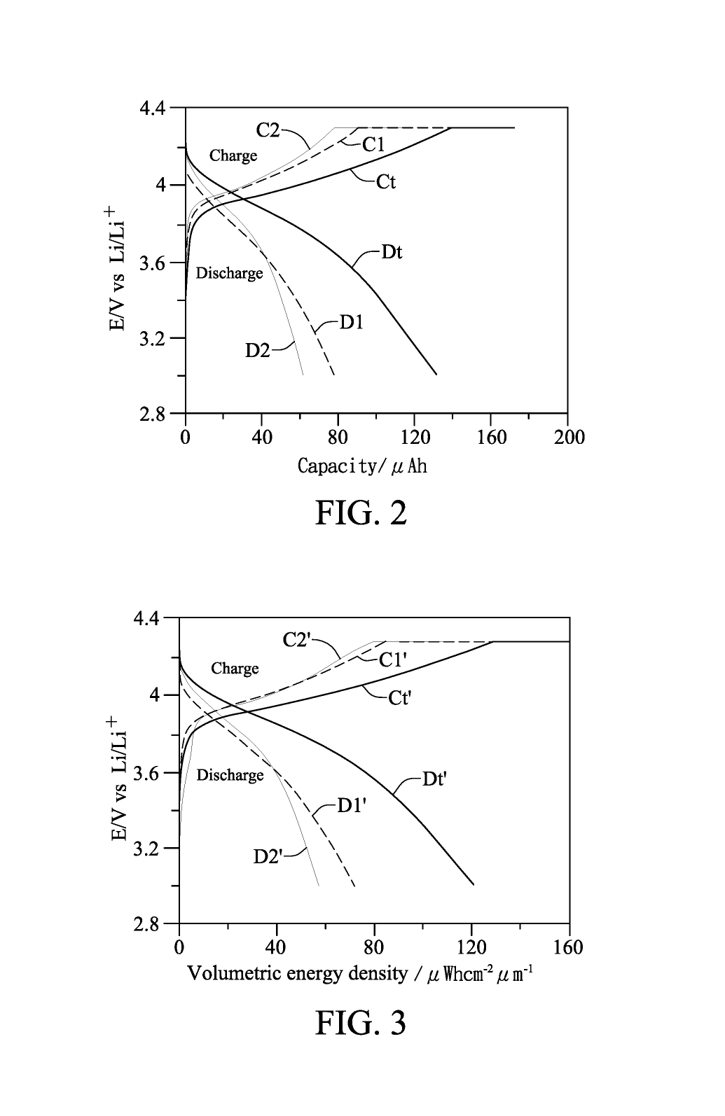

Please refer to FIG. 2, which is the second schematic view of the first embodiment of the double-sided all-solid-state thin-film battery in accordance with the present invention; FIG. 2 illustrates the charge/discharge diagram of the double-sided all-solid-state thin-film battery 1 of the embodiment. As shown in FIG. 2, the curve D1 is the capacity curve of the upper battery structure 1A of the double-sided all-solid-state thin-film battery 1 when the upper battery structure 1A is being discharged; the curve C1 is the capacity curve of the upper battery structure 1A of the double-sided all-solid-state thin-film battery 1 when the upper battery structure 1A is being charged; the curve D2 is the capacity curve of the lower battery structure 1B of the double-sided all-solid-state thin-film battery 1 when the lower battery structure 1B is being discharged; the curve C2 is the capacity curve of the lower battery structure 1B of the double-sided all-solid-state thin-film battery 1 when the lower battery structure 1B is being charged; the curve Dt is the total capacity curve of the upper battery structure 1A and the lower battery structure 1B of the double-sided all-solid-state thin-film battery 1 when the double-sided all-solid-state thin-film battery 1 is being discharged; the curve Ct is the total capacity curve of the upper battery structure 1A and the lower battery structure 1B of the double-sided all-solid-state thin-film battery 1 when the double-sided all-solid-state thin-film battery 1 is being charged.

As shown in FIG. 2, when the upper battery structure 1A and the lower battery structure 1B are separately tested by the discharge test, the capacity of the upper battery structure 1A is 76 μAh, and the capacity of the lower battery structure 1B is 61 μAh. However, when the upper battery structure 1A and the lower battery structure 1B are tested together by the discharge test, the overall capacity of the upper battery structure 1A and the lower battery structure 1B is 129 μAh. Accordingly, the capacity of the double-sided all-solid-state thin-film battery 1 can be more than two times of that of conventional all-solid-state thin-film battery.

Please refer to FIG. 3, which is the third schematic view of the first embodiment of the double-sided all-solid-state thin-film battery in accordance with the present invention; FIG. 3 illustrates the volumetric energy density diagram of the double-sided all-solid-state thin-film battery 1 of the embodiment.

As shown in FIG. 3, the curve D1′ is the volumetric energy density curve of the upper battery structure 1A of the double-sided all-solid-state thin-film battery 1 when the upper battery structure 1A is being discharged; the curve C1′ is the volumetric energy density curve of the upper battery structure 1A of the double-sided all-solid-state thin-film battery 1 when the upper battery structure 1A is being charged; the curve D2′ is the volumetric energy density curve of the lower battery structure 1B of the double-sided all-solid-state thin-film battery 1 when the lower battery structure 1B is being discharged; the curve C2′ is the volumetric energy density curve of the lower battery structure 1B of the double-sided all-solid-state thin-film battery 1 when the lower battery structure 1B is being charged; the curve Dt′ is the total volumetric energy density curve of the upper battery structure 1A and the lower battery structure 1B of the double-sided all-solid-state thin-film battery 1 when the double-sided all-solid-state thin-film battery 1 is being discharged; the curve Ct′ is the total volumetric energy density curve of the upper battery structure 1A and the lower battery structure 1B of the double-sided all-solid-state thin-film battery 1 when the double-sided all-solid-state thin-film battery 1 is being charged.

According to FIG. 3, the volumetric energy density of each of the upper battery structure 1A and the lower battery structure 1B is 50˜70 μWhcm⁻² μm⁻¹; the total volumetric energy density of the double-sided all-solid-state thin-film battery 1 can be up to 121 μWhcm⁻² μm⁻¹, which is almost three times of a common lithium battery (the volumetric energy density of a common lithium battery is 200˜400 Wh/L).

As described above, the double-sided all-solid-state thin-film battery 1 can not only take full advantage of the space of the both sides of the conductive substrate 10 to reduce the cost, but also can effectively increase the overall volumetric energy density of the double-sided all-solid-state thin-film battery 1; thus, the discharge capacity of the double-sided all-solid-state thin-film battery 1 can be more than two times of conventional all-solid-state thin-film battery.

It is worthy to point out that the volumetric energy density of conventional all-solid-state thin-film battery cannot be effectively increased because limited by the processing technology. On the contrary, in the embodiment of the present invention, as the double-sided all-solid-state thin-film battery has special structure and processing technology, each of both sides of the double-sided all-solid-state thin-film battery can have a complete battery structure; therefore, the overall volumetric energy density of the double-sided all-solid-state thin-film battery can be significantly increased.

Also, conventional all-solid-state thin-film battery cannot effectively take full advantage of the space of the both sides of the conductive substrate, so its cost cannot be reduced. On the contrary, according to the embodiments of the present invention, each of the both sides of the double-sided all-solid-state thin-film battery can have a complete battery structure; thus, it can take full advantage of the space of the both sides of the conductive substrate, so its cost can be reduced.

In one embodiment of the present invention, the double-sided all-solid-state thin-film battery is manufactured by a special processing technology, which can execute the film coating process and the annealing process for the both sides of the conductive substrate at the same time; accordingly, the manufacturing time can be significantly reduced to further decrease the cost of the double-sided all-solid-state thin-film battery.

In one embodiment of the present invention, the special structure of the double-sided all-solid-state thin-film battery can dramatically increase the contact area between the current collecting layer and the active material, so the electron conduction paths of the current collecting layer and the active material can increase; for the reason, the electrochemical performance of the double-sided all-solid-state thin-film lithium battery can be improved. As described above, the present invention definitely has an inventive step.

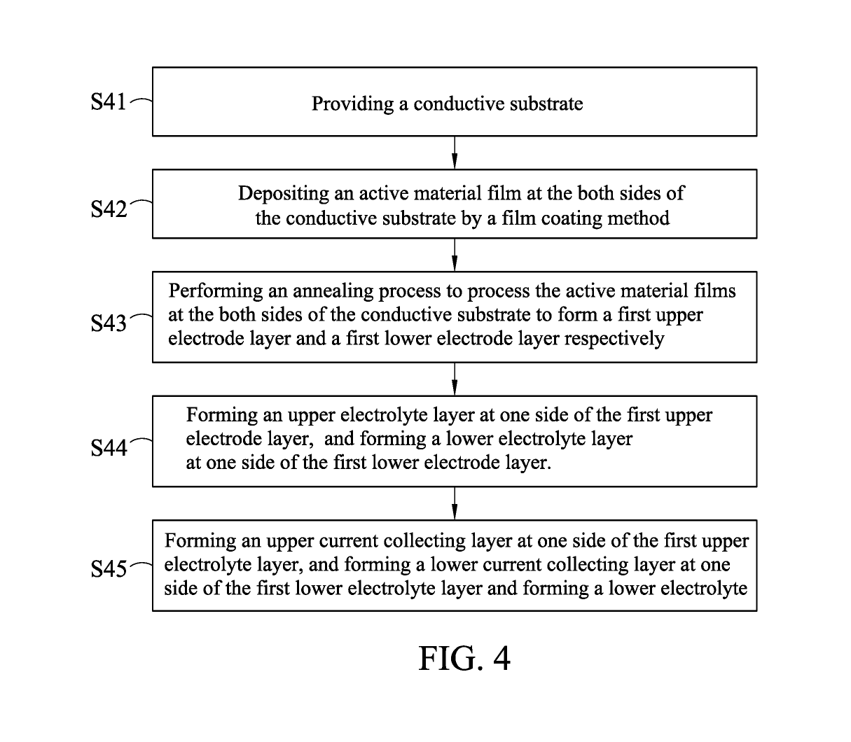

Please refer to FIG. 4, which is the flow chart of the first embodiment of the double-sided all-solid-state thin-film battery in accordance with the present invention. The embodiment may include the following steps:

In the step S41, providing a conductive substrate.

In the step S42, depositing an active material film at the both sides of the conductive substrate by a film coating method.

In the step S43, performing an annealing process to process the active material films at the both sides of the conductive substrate to form a first upper electrode layer and a first lower electrode layer respectively.

In the step S44, forming an upper electrolyte layer at one side of the first upper electrode layer, and forming a lower electrolyte layer at one side of the first lower electrode layer.

In the step S45, forming an upper current collecting layer at one side of the first upper electrolyte layer, and forming a lower current collecting layer at one side of the first lower electrolyte layer.

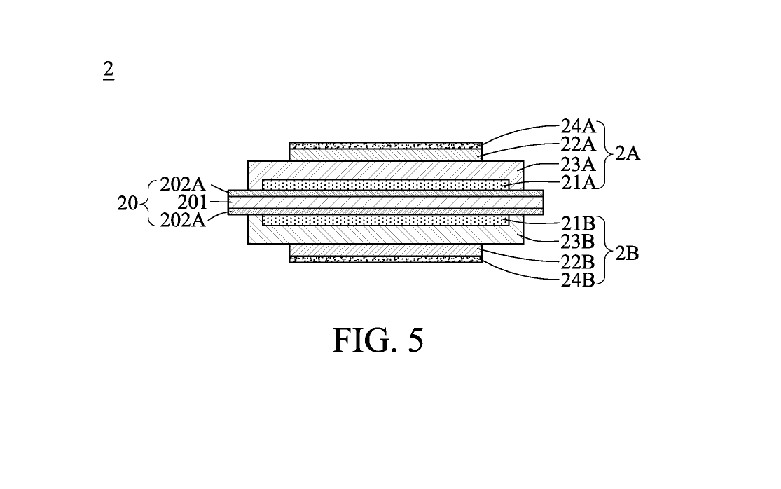

Please refer to FIG. 5, which is the schematic view of the second embodiment of the double-sided all-solid-state thin-film battery in accordance with the present invention. As shown in FIG. 5, the double-sided all-solid-state thin-film lithium battery 2 may include a conductive substrate 20, an upper battery structure 2A, and a lower battery structure 2B. The upper battery structure 2A may include a first upper electrode layer 21A, a second upper electrode 22A, an upper electrolyte layer 23A, and an upper current collecting layer 24A. The lower battery structure 2B may include a first lower electrode layer 21B, a second lower electrode layer 22B, a lower electrolyte layer 23B and a lower current collecting layer 24B.

The first upper electrode layer 21A (the cathode or the anode) may be disposed at one side of the conductive substrate 20. The upper electrolyte layer 23A may be disposed between the first upper electrode layer 21A and the second upper electrode layer 22A (the cathode or the anode). In the embodiment, the upper electrolyte layer 23A may simultaneously contact the conductive substrate 20, the first upper electrode layer 21A, and the second upper electrode layer 22A; the upper electrolyte layer 23A may be solid or colloidal. The upper current collecting layer 24A may be disposed at one side of the second upper electrode layer 22A. The first lower electrode layer 21B (the cathode or the anode) may be disposed at the other side of the conductive substrate 20. The lower electrolyte layer 23B may be disposed between the first lower electrode layer 21B and the second lower electrode layer 22B (the cathode or the anode). In the embodiment, the lower electrolyte layer 23B may simultaneously contact the conductive substrate 20, the first lower electrode layer 21B, and the second lower electrode layer 22B; the lower electrolyte layer 23B may be solid or colloidal. The lower current collecting layer 24B may be disposed at one side of the second lower electrode layer 22B.

The difference between the embodiment and the previous embodiment is that the conductive substrate 20 may include an isolation substrate 201, a first substrate current collecting layer 202A, and a second substrate current collecting layer 202B. The first substrate current collecting layer 202A may be disposed at one side of the isolation substrate 201, and the second substrate current collecting layer 202B may be disposed at the other side of the isolation substrate 201. The detailed manufacturing method and the other technical features of the embodiment are similar to the previous embodiment, so which will not be described herein.

In summation of the description above, in one embodiment of the present invention, each of both sides of the double-sided all-solid-state thin-film battery can have a complete battery structure; therefore, the overall volumetric energy density of the double-sided all-solid-state thin-film battery can be significantly increased

Also, in one embodiment of the present invention, each of the both sides of the double-sided all-solid-state thin-film battery can have a complete battery structure; thus, it can take full advantage of the space of the both sides of the conductive substrate, so its cost can be reduced.

Besides, in one embodiment of the present invention, the double-sided all-solid-state thin-film battery can be manufactured by a special processing technology, which can execute the film coating process and the annealing process for the both sides of the conductive substrate at the same time; accordingly, the manufacturing time can be significantly reduced to further decrease the cost of the double-sided all-solid-state thin-film battery.

Moreover, in one embodiment of the present invention, the special structure of the double-sided all-solid-state thin-film battery can dramatically increase the contact area between the current collecting layer and the active material, so the electron conduction paths of the current collecting layer and the active material can increase; as a result, the electrochemical performance of the double-sided all-solid-state thin-film lithium battery can be effectively improved.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A double-sided all-solid-state thin-film lithium battery, comprising:
a conductive substrate;
a first upper electrode layer, disposed at one side of the conductive substrate;
a second upper electrode layer;
an upper electrolyte layer, disposed between the first upper electrode layer and the second upper electrode layer;
an upper current collecting layer, disposed at one side of the second upper electrode layer;
a first lower electrode layer, disposed at the other side of the conductive substrate;
a second lower electrode layer;
a lower electrolyte layer, disposed between the first lower electrode layer and the second lower electrode layer; and
a lower current collecting layer, disposed at one side of the second lower electrode layer.

2. The double-sided all-solid-state thin-film lithium battery of claim 1, wherein each of the first upper electrode layer, the second upper electrode layer, the first lower electrode layer, and the second lower electrode layer comprise an active material.

3. The double-sided all-solid-state thin-film lithium battery of claim 2, wherein the active material is LiMn₂O₄, LiCoO₂, LiFePO₄, LiNiO₂, C, Si, SnO₂, TiO₂, Li, or a derivative, an alloy, a composite thereof.

4. The double-sided all-solid-state thin-film lithium battery of claim 1, wherein the upper electrolyte layer simultaneously contacts the conductive substrate, the first upper electrode layer, and the second upper electrode layer.

5. The double-sided all-solid-state thin-film lithium battery of claim 4, wherein the lower electrolyte layer simultaneously contacts the conductive substrate, the first lower electrode layer, and the second lower electrode layer.

6. The double-sided all-solid-state thin-film lithium battery of claim 1, wherein the conductive substrate is a metal substrate.

7. The double-sided all-solid-state thin-film lithium battery of claim 6, wherein the metal substrate is a stainless steel substrate.

8. The double-sided all-solid-state thin-film lithium battery of claim 1, wherein the conductive substrate comprises an isolation substrate, a first substrate current collecting layer, and a second substrate current collecting layer; the first substrate current collecting layer is disposed at one side of the isolation substrate, and the second substrate current collecting layer is disposed at the other side of the isolation substrate.

9. The double-sided all-solid-state thin-film lithium battery of claim 1, wherein the upper electrolyte layer and the lower electrolyte layer are solid or colloidal.

10. A method for manufacturing a double-sided all-solid-state thin-film lithium battery, comprising:
providing a conductive substrate;
depositing an active material film at both sides of the conductive substrate by a film coating method to form a first upper electrode layer and a first lower electrode layer respectively; and
forming an upper electrolyte layer at one side of the first upper electrode layer, and forming a lower electrolyte layer at one side of the first lower electrode layer.

11. The method for manufacturing the double-sided all-solid-state thin-film lithium battery of claim 10, further comprising:
forming an upper current collecting layer at one side of the first upper electrolyte layer, and forming a lower current collecting layer at one side of the first lower electrolyte layer.

12. The method for manufacturing the double-sided all-solid-state thin-film lithium battery of claim 10, further comprising:
performing an annealing process to process the active material films at the both sides of the conductive substrate.

13. The method for manufacturing the double-sided all-solid-state thin-film lithium battery of claim 10, wherein the active material is LiMn₂O₄, LiCoO₂, LiFePO₄, LiNiO₂, C, Si, SnO₂, TiO₂, Li, or a derivative, an alloy, a composite thereof.

14. The method for manufacturing the double-sided all-solid-state thin-film lithium battery of claim 14, wherein the upper electrolyte layer simultaneously contacts the conductive substrate, the first upper electrode layer, and the second upper electrode layer.

15. The method for manufacturing the double-sided all-solid-state thin-film lithium battery of claim 14, wherein the lower electrolyte layer simultaneously contacts the conductive substrate, the first lower electrode layer, and the second lower electrode layer.

16. The method for manufacturing the double-sided all-solid-state thin-film lithium battery of claim 10, wherein the conductive substrate is a metal substrate.

17. The method for manufacturing the double-sided all-solid-state thin-film lithium battery of claim 16, wherein the metal substrate is a stainless steel substrate.

18. The method for manufacturing the double-sided all-solid-state thin-film lithium battery of claim 10, wherein the conductive substrate comprises an isolation substrate, a first substrate current collecting layer, and a second substrate current collecting layer; the first substrate current collecting layer is disposed at one side of the isolation substrate, and the second substrate current collecting layer is disposed at the other side of the isolation substrate.

19. The method for manufacturing the double-sided all-solid-state thin-film lithium battery of claim 10, wherein the upper electrolyte layer and the lower electrolyte layer are solid or colloidal.

20. The method for manufacturing the double-sided all-solid-state thin-film lithium battery of claim 10, wherein the film coating method is a vacuum thermal evaporation, a radio frequency sputtering, a radio frequency magnetron sputtering, a chemical vapor deposition, an electrospray deposition, a pulsed laser deposition, a slurry coating, and a sol-gel method.
